(19) United States
(12) Patent Application Publication
(10) Pub. No.: US 2016/0088305 A1
(43) Pub. Date: Mar. 24, 2016

(54) METHOD AND APPARATUS FOR PROCESSING VIDEO SIGNAL

(71) Applicant: WILUS INSTITUTE OF STANDARDS AND TECHNOLOGY INC., Seoul (KR)

(72) Inventor: Hyunoh OH, Gwacheon-si, Gyeonggido (KR)

(73) Assignee: WILUS INSTITUTE OF STANDARDS AND TECHNOLOGY INC., Seoul (KR)

(21) Appl. No.: 14/784,953

(22) PCT Filed: Apr. 17, 2014
(86) PCT No.: PCT/KR2014/003373

§ 371 Date: Oct. 15, 2015

Related U.S. Application Data
(60) Provisional application No. 61/813,155, filed on Apr. 17, 2013.
(60) Provisional application No. 61/814,324, filed on Apr. 21, 2013.

(51) Int. Cl. H04N 19/30; H04N 19/187; H04N 19/50; H04N 19/44

(52) U.S. Cl. CPC H04N 19/30; H04N 19/44; H04N 19/187; H04N 19/50

(57) ABSTRACT

The present invention provides a method and an apparatus for processing a video signal, and more particularly, a method and an apparatus for processing a video signal, which encode and decode the video signal.

To this end, the present invention provides a method for processing a video signal, including: receiving a scalable video signal including a base layer and an enhancement layer; receiving interlayer constrained partition sets information, the interlayer constrained partition sets information indicating whether interlayer prediction is performed only in a designated partition set; decoding pictures of the base layer; and decoding pictures of the enhancement layer by referring to the decoded pictures of the base layer, wherein in the decoding of the pictures of the enhancement layer, the interlayer prediction is performed only in the designated partition set based on the interlayer constrained partition sets information and an apparatus for processing a video signal using the same.

### TECHNICAL FIELD

The present invention relates to a method and an apparatus for processing a video signal, and more particularly, to a method and an apparatus for processing a video signal, which encode and decode the video signal.

### BACKGROUND ART

Compressive coding means a series of signal processing technologies for transmitting digitalized information through a communication line or storing the digitalized information in a form suitable for a storage medium. Objects of the compressive coding include a voice, an image, a character, and the like and in particular, a technology that performs compressive coding the image is called video image compression. Compressive coding of a video signal is achieved by removing redundant information by considering a spatial correlation, a temporal correlation, a probabilistic correlation, and the like. However, with the recent development of various media and data transmission media, a method and an apparatus of video signal processing with higher-efficiency are required.

Meanwhile, in recent years, with a change of a user environment such as network condition or a resolution of a terminal in various multimedia environments, a demand for a scalable video coding scheme for hierarchically providing video contents has increased in spatial, temporal, and/or image quality terms.

### DISCLOSURE

### Technical Problem

The present invention has been made in an effort to increase coding efficiency of a video signal. In particular, the present invention has been made in an effort to provide an efficient coding method of a scalable video signal.

### Technical Solution

An exemplary embodiment of the present invention provides a method for processing a video signal, including: receiving a scalable video signal including a base layer and an enhancement layer; receiving interlayer constrained partition sets information (interlayer constrained partition sets SEI message), the interlayer constrained partition sets information indicating whether interlayer prediction is performed only in a designated partition set; decoding pictures of the base layer; and decoding pictures of the enhancement layer by referring to the decoded pictures of the base layer, wherein in the decoding of the pictures of the enhancement layer, the interlayer prediction is performed only in the designated partition set based on the interlayer constrained partition sets information (interlayer constrained partition sets SEI message).

Another exemplary embodiment of the present invention provides an apparatus for processing a video signal, including: a demultiplexer receiving a scalable video signal including a base layer and an enhancement layer and receiving interlayer constrained partition sets information, the interlayer constrained partition sets information indicating whether interlayer prediction is performed only in a designated partition set; a base layer decoder decoding pictures of the base layer; and an enhancement layer decoder decoding pictures of the enhancement layer by using the decoded pictures of the base layer.

### Advantageous Effects

According to exemplary embodiments of the present invention, interlayer prediction can be efficiently supported with respect to a scalable video signal using a multi-loop decoding scheme.

### DESCRIPTION OF DRAWINGS

FIG. 1 is a schematic block diagram of a video signal encoder according to an exemplary embodiment of the present invention.

FIG. 2 is a schematic block diagram of a video signal decoder according to an exemplary embodiment of the present invention.

FIG. 3 is a diagram illustrating one example of dividing a coding unit according to an exemplary embodiment of the present invention.

FIG. 4 is a diagram illustrating an exemplary embodiment of a method that hierarchically shows a partition structure of FIG. 3.

FIG. 5 is a diagram illustrating prediction units having various sizes and forms according to an exemplary embodiment of the present invention.

FIG. 6 is a diagram illustrating an exemplary embodiment in which one picture is partitioned into a plurality of slices.

FIG. 7 is a diagram illustrating an exemplary embodiment in which one picture is partitioned into a plurality of tiles.

FIG. 8 is a schematic block diagram of a scalable video coding system according to an exemplary embodiment of the present invention.

FIG. 9 is a diagram illustrating a base layer picture of a scalable video signal and an upsampling picture corresponding thereto according to an exemplary embodiment of the present invention.

FIG. 10 is a diagram illustrating upsampled samples on a partition boundary according to the present invention.

FIG. 11 is a diagram illustrating an exemplary embodiment of a base layer picture, an upsampled base layer picture, and an enhancement layer picture having a plurality of partitions.

FIG. 12 is a diagram illustrating upsampling mode information indicating an upsampling scheme as an exemplary embodiment of the present invention.

FIGS. 13 to 15 are diagrams illustrating flag information indicating whether to perform upsampling according to each partition type as another exemplary embodiment of the present invention.

FIG. 16 is a diagram illustrating tile sets which exist in a base layer picture 40a and an enhancement layer picture 40c according to an exemplary embodiment of the present invention.

FIG. 17 is a diagram illustrating an exemplary embodiment of the base layer picture and the enhancement layer picture having different partition boundaries.

### BEST MODE

Terms used in the specification adopt general terms which are currently widely used as possible by considering functions in the present invention, but the terms may be changed depending on an intention of those skilled in the art, customs, and emergence of new technology. Further, in a specific case, there is a term arbitrarily selected by an applicant and in this case, a meaning thereof will be described in a corresponding description part of the invention. Accordingly, it should be revealed that a term used in the specification should be analyzed based on not just a name of the term but a substantial meaning of the term and contents throughout the specification.

A following term may be analyzed based on the following criterion and even a term which is not described may be analyzed according to the following intent. In some cases, coding may be interpreted as encoding or decoding and information is a term including all of values, parameters, coefficients, elements, and the like and since in some cases, a meaning of the information may be differently interpreted, the present invention is not limited thereto. A ‘unit’ is used as a meaning that designates a basic unit of image (picture) processing or a specific location of the picture and in some cases, may be used while being mixed with a term such as a ‘block’, a ‘partition’, or an ‘area’. Further, in the specification, the unit can be used as a concept including all of a coding unit, a prediction unit, and a transform unit.

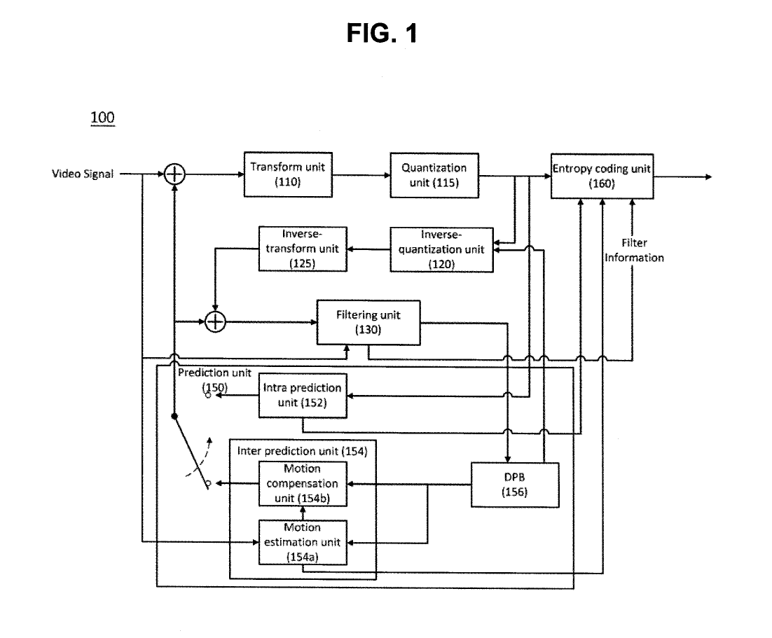

FIG. 1 is a schematic block diagram of a video signal encoding apparatus according to an exemplary embodiment of the present invention. Referring to FIG. 1, the encoding apparatus 100 of the present invention generally includes a transform unit 110, a quantization unit 115, an inverse-quantization unit 120, an inverse-transform unit 125, a filtering unit 130, a prediction unit 150, and an entropy coding unit 160.

The transform unit 110 obtains transform coefficient values by transforming pixel values of a received video signal. For example, discrete cosine transform (DCT) or wavelet transform may be used. In particular, in the discrete cosine transform, an input picture signal is partitioned into block forms having a predetermined size to be transformed. Coding efficiency may vary depending on distributions and characteristics of values in a transform area in the transformation.

The quantization unit 115 quantizes the transform coefficient values output from the transform unit 110. The inverse-quantization unit 120 inversely quantizes the transform coefficient values and the inverse-transform unit 125 restores original pixel values by using the inversely quantized transform coefficient values.

The filtering unit 130 performs a filtering operation for enhancing the quality of the restored picture. For example, the filtering unit 130 may include a deblocking filter and an adaptive loop filter. The filtered picture is stored in a decoded picture buffer 156 to be output or used as a reference picture.

In order to increase the coding efficiency, a method of predicting the picture by using an already coded area through the prediction unit 150 and acquiring the restored picture by adding residual values between an original picture and the predicted picture to the predicted picture is used instead of coding the picture signal as it is. An intra prediction unit 152 performs intra prediction in a current picture and an inter prediction unit 154 predicts the current picture by using the reference picture stored in the decoded picture buffer 156. The intra prediction unit 152 performs the intra prediction from restored areas in the current picture to transfer intra-encoded information to the entropy coding unit 160. The inter prediction unit 154 may be configured to include a motion estimation unit 154a and a motion compensation unit 154b. The motion estimation unit 154a acquires a motion vector value of a current area by referring to a restored specific area. The motion estimation unit 154a transfers positional information (a reference frame, a motion vector, and the like) of the reference area to the entropy coding unit 160 to be included in a bitstream. The motion compensation unit 154b performs inter-picture motion compensation by using the motion vector value transferred from the motion estimation unit 154a.

The entropy coding unit 160 entropy-codes the quantized transform coefficient, the inter-encoded information, the intra-encoded information, and the reference area information input from the inter prediction unit 154 to generate a video signal bitstream. Herein, in the entropy coding unit 160, a variable length coding (VLC) scheme and arithmetic coding may be used. In the variable length coding (VLC) scheme, input symbols are transformed to a consecutive codeword and the length of the codeword may be variable. For example, symbols which are frequently generated are expressed by a short codeword and symbols which are not frequently generated are expressed by a long codeword. As the variable length coding scheme, a context-based adaptive variable length coding (CAVLC) scheme may be used. In the arithmetic coding, consecutive data symbols are transformed to one decimal and in the arithmetic coding, an optimal decimal bit required to express each symbol may be acquired. As the arithmetic coding, context-based adaptive binary arithmetic code (CABAC) may be used.

The generated bitstream is capsulized by using a network abstraction layer (NAL) unit as a basic unit. The NAL unit includes an encoded slice segment and the slice segment is constituted by an integer number of coding tree units. A video decoder needs to first separate the bitstream into the NAL units and thereafter, decode the respective separated NAL units in order to decode the bitstream.

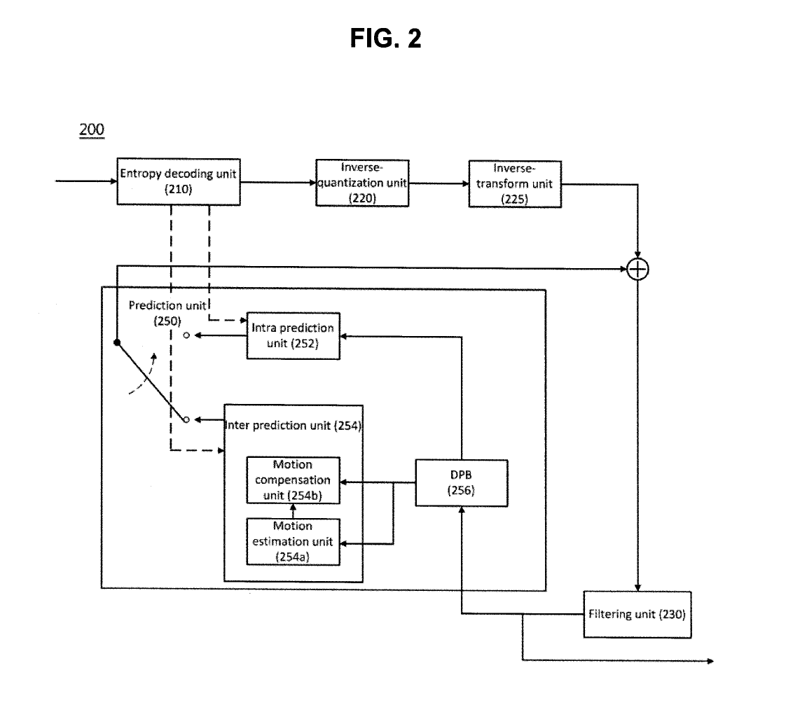

FIG. 2 is a schematic block diagram of a video signal decoding apparatus 200 according to an exemplary embodiment of the present invention. Referring to FIG. 2, the decoding apparatus 200 of the present invention generally includes an entropy decoding unit 210, an inverse-quantization unit 220, an inverse-transform unit 225, a filtering unit 230, and a prediction unit 250.

The entropy decoding unit 210 entropy-decodes a video signal bitstream to extract the transform coefficient, the motion vector, and the like for each area. The inverse-quantization unit 220 inversely quantizes the entropy-decoded transform coefficient and the inverse-transform unit 225 restores original pixel values by using the inversely quantized transform coefficient.

Meanwhile, the filtering unit 230 improves the image quality by filtering the picture. Herein, the filtering unit 230 may include a deblocking filter for reducing a block distortion phenomenon and/or an adaptive loop filter for removing distortion of the entire picture. The filtered picture is stored in a decoded picture buffer 256 to be output or used as a reference picture for a next frame.

The prediction unit 250 of the present invention includes an intra prediction unit 252 and an inter prediction unit 254 and restores a prediction picture by using information such as an encoding type, the transform coefficient for each area, the motion vector, and the like decoded through the aforementioned entropy decoding unit 210.

In this regard, the intra prediction unit 252 performs intra prediction from decoded samples in the current picture. The inter prediction unit 254 generates the prediction picture by using the reference picture stored in the decoded picture buffer 256 and the motion vector. The inter prediction unit 254 may be configured to include a motion estimation unit 254a and a motion compensation unit 254b. The motion estimation unit 254a acquires the motion vector representing the positional relationship between a current block and a reference block of the reference picture used for coding and transfers the acquired motion vector to the motion compensation unit 254b.

Prediction values output from the intra prediction unit 252 or the inter prediction unit 254 and a pixel values output from the inverse-transform unit 225 are added to each other to generate a restored video frame.

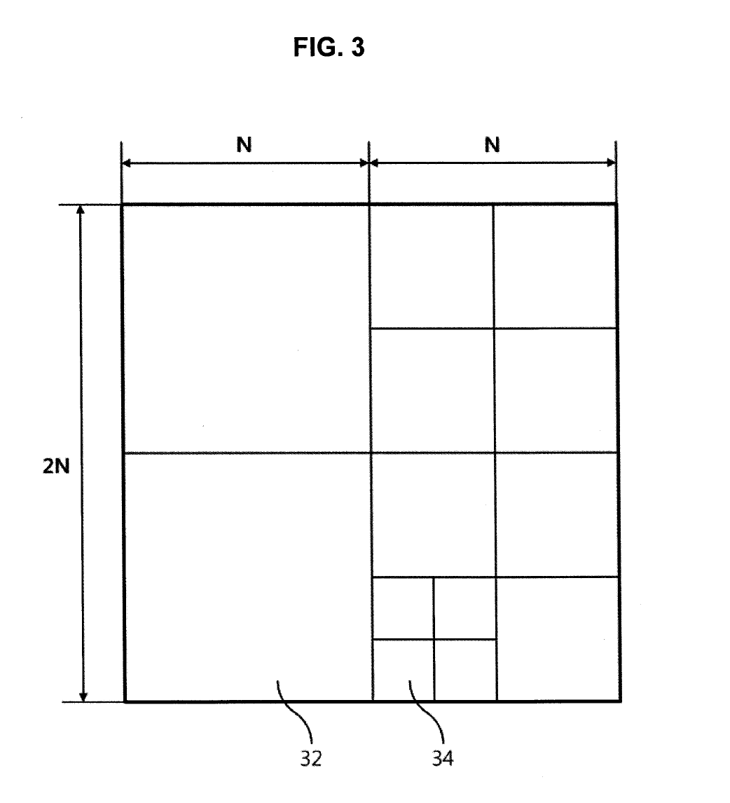

Hereinafter, in operations of the encoding apparatus 100 and the decoding apparatus 200, a method for partitioning a coding unit and a prediction unit will be described with reference to FIGS. 3 to 5.

The coding unit means a basic unit for processing the picture during the aforementioned processing process of the video signal such as the intra/inter prediction, the transform, the quantization and/or the entropy coding. The size of the coding unit used in coding one picture may not be constant. The coding unit may have a quadrangular shape and one coding unit may be partitioned into several coding units again.

FIG. 3 is a diagram illustrating one example of partitioning a coding unit according to an exemplary embodiment of the present invention. For example, one coding unit having a size of 2N×2N may be partitioned into four coding units having a size of N×N again. The coding unit may be recursively partitioned and all coding units need not be partitioned in the same pattern. However, for easy coding and processing processes, the maximum size of a coding unit 32 and/or the minimum size of a coding unit 34 may be limited.

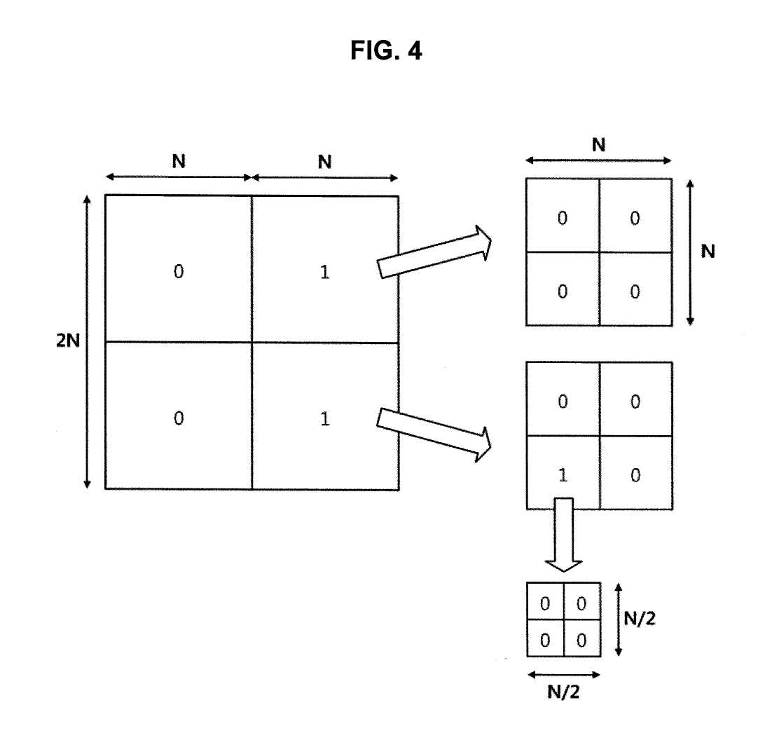

In regard to one coding unit, information indicating whether the corresponding coding unit is partitioned may be stored. FIG. 4 is a diagram illustrating an exemplary embodiment of a method that hierarchically shows a partition structure of the coding unit illustrated in FIG. 3 by using a flag value. As the information indicating whether the coding unit is partitioned, when the corresponding unit is partitioned, a value of ‘1’ may be allocated and when the corresponding unit is not partitioned, a value of ‘0’ may be allocated. As illustrated in FIG. 4, when a flag value indicating whether the coding unit is partitioned is 1, a coding unit corresponding to a relevant node may be partitioned into 4 coding units again and when the flag value is 0, the coding unit is not partitioned any longer and a processing process for the corresponding coding unit may be performed.

The structure of the coding unit may be expressed by using a recursive tree structure. That is, regarding one picture or the coding unit having the maximum size as a root, the coding unit partitioned into other coding units has child nodes as many as the partitioned coding units. Therefore, a coding unit which is not partitioned any longer becomes a leaf node. When it is assumed that one coding unit may be partitioned only in a square shape, since one coding unit may be partitioned into a maximum of four different coding units, a tree representing the coding unit may be formed in a guard tree shape.

In an encoder, the optimal size of the coding unit may be selected according to a characteristic (e.g., resolution) of a video picture or by considering the coding efficiency, and information on the selected optimal size or information which may derive the selected optimal size may be included in the bitstream. For example, the maximum size of the coding unit and the maximum depth of the tree may be defined. When the coding unit is partitioned in the square shape, since the height and the width of the coding unit is half as small as the height and the width of the coding unit of a parent node, the minimum coding unit size may be acquired by using the information. Alternatively, on the contrary, the minimum coding unit size and the maximum depth of the tree are predefined and used and the maximum coding unit size may be derived and used by using the predefined minimum coding unit size and maximum tree depth. In the square partition, since the size of the unit varies in the form of a multiple of 2, the actual coding unit size is expressed by a log value having 2 as the base to increase transmission efficiency.

In a decoder, information indicating whether a current coding unit is partitioned may be acquired. When the information is acquired (transmitted) only under a specific condition, efficiency may be increased. For example, since it is a partitionable condition of the current coding unit that a size acquired by adding a current coding unit size at a current position is smaller than the size of the picture and the current coding unit size is larger than a predetermined minimum coding unit size, the information indicating whether the current coding unit is partitioned may be acquired only in this case.

When the information indicates that the coding unit is partitioned, the sizes of the coding units to be partitioned are half as small as the current coding unit and the coding unit is partitioned into four square coding units based on a current processing position. The processing may be repeated with respect to each of the partitioned coding units.

Picture prediction (motion compensation) for coding is performed with respect to the coding unit (that is, the leaf node of the coding unit tree) which is not partitioned any longer. Hereinafter, a basic unit that performs the prediction will be referred to as a prediction unit or a prediction block.

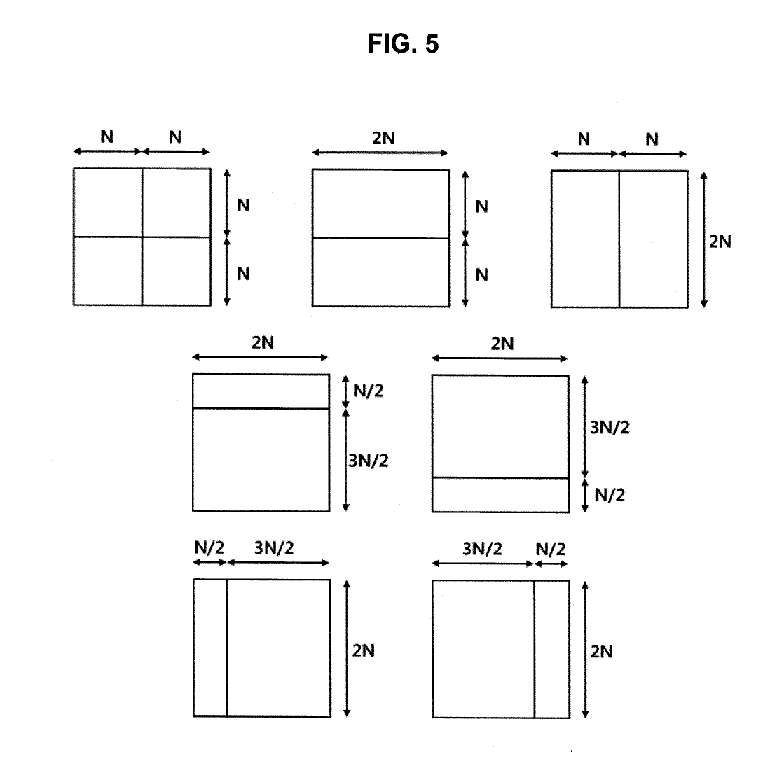

FIG. 5 is a diagram illustrating prediction units having various sizes and forms according to an exemplary embodiment of the present invention. The prediction units may have shapes including a square shape, a rectangular shape, and the like in the coding unit. For example, one prediction unit may not be partitioned (2N×2N) or may be partitioned to have various sizes and forms including N×N, 2N×N, N×2N, 2N×N/2, 2N×3N/2, N/2×2N, 3N/2×2N, and the like as illustrated in FIG. 5. Further, a partitionable form of the prediction unit may be defined differently in the intra coding unit and the inter coding unit. For example, in the intra coding unit, only partitioning having the form of 2N×2N or N×N is available and in the inter coding unit, all forms of partitioning which is mentioned above may be configured to be available. In this case, the bitstream may include information indicating whether the prediction unit is partitioned or information indicating which form the prediction unit is partitioned in. Alternatively, the information may be derived from other information.

Hereinafter, a term called the unit used in the specification may be used as a term which substitutes for the prediction unit as the basic unit that performs prediction. However, the present invention is not limited thereto and the unit may be, in a broader sense, appreciated as a concept including the coding unit.

A current picture in which the current unit is included or decoded portions of other pictures may be used in order to restore the current unit in which decoding is performed. A picture (slice) using only the current picture for restoration, that is, performing only the intra prediction is referred to as an intra picture or an I picture (slice) and a picture (slice) that may perform both the intra prediction and the inter prediction is referred to as an inter picture (slice). A picture (slice) using a maximum of one motion vector and reference index is referred to as a predictive picture or a P picture (slice) and a picture (slice) using a maximum of two motion vectors and reference indexes is referred to as a bi-predictive picture or a B picture (slice), in order to predict each unit in the inter picture (slice).

The intra prediction unit performs intra prediction of predicting pixel values of a target unit from restored areas in the current picture. For example, pixel values of the current unit may be predicted from encoded pixels of units positioned at the upper end, the left side, the upper left end and/or the upper right end based on the current unit.

Meanwhile, the inter prediction unit performs inter prediction of predicting the pixel values of the target unit by using information of not the current picture but other restored pictures. In this case, a picture used for prediction is referred to as the reference picture. During the inter prediction, which reference area is used to predict the current unit may be expressed by using index and motion vector information indicating the reference picture including the corresponding reference area.

The inter prediction may include forward direction prediction, backward direction prediction, and bi-prediction. The forward direction prediction means prediction using one reference picture displayed (alternatively, output) temporally before the current picture and the backward direction prediction means prediction using one reference picture displayed (alternatively, output) temporally after the current picture. To this end, one set of motion information (e.g., the motion vector and reference picture index) may be required. In the bi-prediction scheme, a maximum of two reference areas may be used and two reference areas may exist in the same reference picture or in each of different pictures. That is, in the bi-prediction scheme, a maximum of 2 sets of motion information (e.g., the motion vector and reference picture index) may be used and two motion vectors may have the same reference picture index or different reference picture indexes. In this case, the reference pictures may be displayed (alternatively, output) temporally both before and after the current picture.

The reference unit of the current unit may be acquired by using the motion vector and reference picture index. The reference unit exists in the reference picture having the reference picture index. Further, pixel values or interpolated values of a unit specified by the motion vector may be used as prediction values (predictor) of the current unit. For motion prediction having pixel accuracy per sub-pixel, for example, an 8-tab interpolation filter and a 4-tab interpolation filter may be used with respect to luminance samples (luma samples) and chrominance samples (chroma samples), respectively. As described above, by using motion information, motion compensation that predicts a texture of the current unit from a previously decoded picture is performed.

Meanwhile, a reference picture list may be constituted by pictures used for the inter prediction with respect to the current picture. In the case of B picture, two reference picture lists are required and hereinafter, the respective reference picture lists are designated by reference picture list 0 (alternatively, L0) and reference picture list 1 (alternatively, L1).

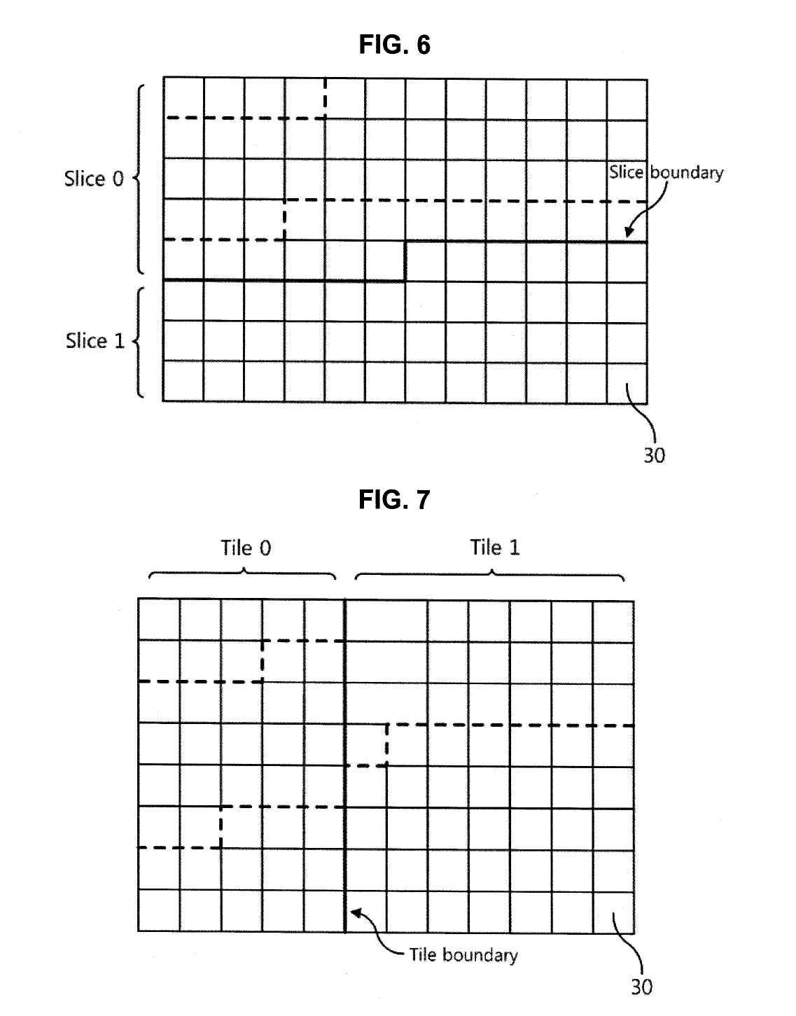

One picture may be divided into the slices, slice segments, tiles, etc. FIGS. 6 and 7 illustrate various exemplary embodiments in which the picture is partitioned.

First, FIG. 6 illustrates an exemplary embodiment in which one picture is partitioned into a plurality of slices (slice 0 and slice 1). In FIG. 6, a thick line represents a slice boundary and a dotted line represents a slice segment boundary.

The slice may be constituted by one independent slice segment or constituted by a set of one independent slice segment and at least one dependent slice segment which is continuous with the independent slice segment. The slice segment is a sequence of a coding tree unit (CTU) 30. That is, the independent or dependent slice segment is constituted by at least one CTU 30.

According to the exemplary embodiment of FIG. 6, one picture is partitioned into two slices, that is, slice 0 and slice 1. Between them, slice 0 is constituted by a total of three slice segments, that is, the independent slice segment including 4 CTUs, the dependent slice segment including 35 CTUs, and another dependent slice segment including 15 CTUs. Further, slice 1 is constituted by one independent slice segment including 42 CTUs.

Next, FIG. 7 illustrates an exemplary embodiment in which one picture is partitioned into a plurality of tiles (tile 0 and tile 1). In FIG. 7, a thick line represents a tile boundary and a dotted line represents the slice segment boundary.

The tile is the sequence of the CTU 30 similarly to the slice and has the rectangular shape. According to the exemplary embodiment of FIG. 7, one picture is partitioned into two tiles, that is, tile 0 and tile 1. Further, in FIG. 7, the corresponding picture is constituted by one slice and includes one independent slice segment and four continuous dependent slice segments. Although not illustrated in FIG. 7, one tile may be partitioned into a plurality of slices. That is, one tile may be constituted by the CTUs included in one or more slices. Similarly, one slice may be constituted by the CTUs included in one or more tiles. However, each slice and tile needs to satisfy at least one of the following conditions. i) All CTUs included in one slice belong to the same tile. ii) All CTUs included in one tile belong to the same slice. As such, one picture may be partitioned into the slice and/or tile and each partition (slice and tile) may be encoded or decoded in parallel.

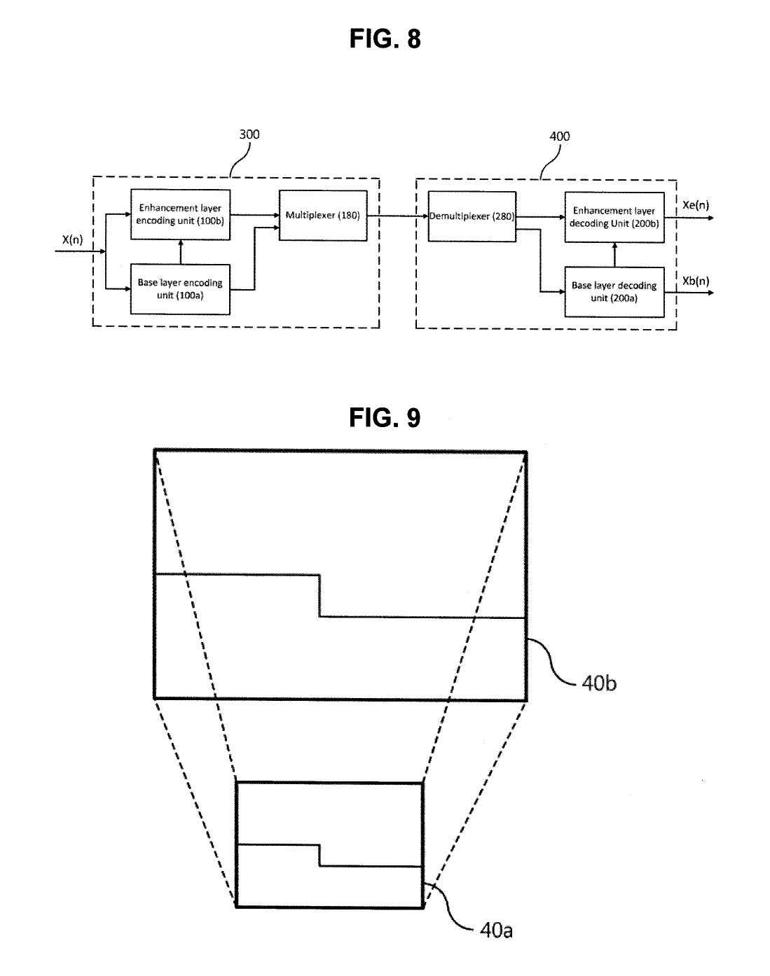

FIG. 8 is a schematic block diagram of a scalable video coding (alternatively, scalable high-efficiency video coding) system according to an exemplary embodiment of the present invention.

The scalable video coding scheme is a compression method for hierarchically providing video contents in spatial, temporal, and/or image quality terms according to various user environments such as a situation of a network or a resolution of a terminal in various multimedia environments. Spatial scalability may be supported by encoding the same picture with different resolutions for each layer and temporal scalability may be implemented by controlling a screen playback rate per second of the picture. Further, quality scalability encodes quantization parameters differently for each layer to provide pictures with various image qualities. In this case, a picture sequence having lower resolution, the number of frames per second and/or quality is referred to as a base layer, and a picture sequence having relatively higher resolution, the number of frames per second and/or quality is referred to as an enhancement layer.

Hereinafter, a configuration of the scalable video coding system of the present invention will be described in more detail with reference to FIG. 8. The scalable video coding system includes an encoding apparatus 300 and a decoding apparatus 400. The encoding apparatus 300 may include a base layer encoding unit 100a, an enhancement layer encoding unit 100b, and a multiplexer 180 and the decoding apparatus 400 may include a demultiplexer 280, a base layer decoding unit 200a, and an enhancement layer decoding unit 200b. The base layer encoding unit 100a compresses an input signal X(n) to generate a base bitstream. The enhancement layer encoding unit 100b may generate an enhancement layer bitstream by using the input signal X(n) and information generated by the base layer encoding unit 100a. The multiplexer 180 generates a scalable bitstream by using the base layer bitstream and the enhancement layer bitstream.

Basic configurations of the base layer encoding unit 100a and the enhancement layer encoding unit 100b may be the same as or similar to that of the encoding apparatus 100 illustrated in FIG. 1. However, the inter prediction unit of the enhancement layer encoding unit 100b may perform inter prediction by using motion information generated by the base layer encoding unit 100a. Further, a decoded picture buffer (DPB) of the enhancement layer encoding unit 100b may sample and store the picture stored in the decoded picture buffer (DPB) of the base layer encoding unit 100a. The sampling may include resampling, upsampling, and the like as described below.

The generated scalable bitstream may be transmitted to the decoding apparatus 400 through a predetermined channel and the transmitted scalable bitstream may be partitioned into the enhancement layer bitstream and the base layer bitstream by the demultiplexer 280 of the decoding apparatus 400. The base layer decoding unit 200a receives the base layer bitstream and restores the received base layer bitstream to generate an output signal Xb(n). Further, the enhancement layer decoding unit 200b receives the enhancement layer bitstream and generates an output signal Xe(n) by referring to the signal restored by the base layer decoding unit 200a.

Basic configurations of the base layer decoding unit 200a and the enhancement layer decoding unit 200b may be the same as or similar to those of the decoding apparatus 200 illustrated in FIG. 2. However, the inter prediction unit of the enhancement layer decoding unit 200b may perform inter prediction by using motion information generated by the base layer decoding unit 200a. Further, a decoded picture buffer (DPB) of the enhancement layer decoding unit 200b may sample and store the picture stored in the decoded picture buffer (DPB) of the base layer decoding unit 200a. The sampling may include resampling, upsampling, and the like.

Meanwhile, in the scalable video coding, interlayer prediction may be used for efficient prediction. The interlayer prediction means predicting a picture signal of a higher layer by using motion information, syntax information, and/or texture information of a lower layer. In this case, the lower layer referred for encoding the higher layer may be referred to as a reference layer. For example, the enhancement layer may be coded by using the base layer as the reference layer.

The reference unit of the base layer may be scaled up or down through sampling. The sampling may mean changing image resolution or quality. The sampling may include the resampling, downsampling, the upsampling, and the like. For example, intra samples may be resampled in order to perform the interlayer prediction. Alternatively, pixel data is regenerated by using a downsampling filter to reduce the image resolution and this is referred to as the downsampling. Alternatively, additional pixel data is generated by using an upsampling filter to increase the image resolution and this is referred to as the upsampling. A term called the sampling in the present invention may be appropriately analyzed according to the technical spirit and the technical scope of the exemplary embodiment.

A decoding scheme of the scalable video coding generally includes a single-loop scheme and a multi-loop scheme. In the single-loop scheme, only pictures of a layer to be actually reproduced are decoded, and other pictures except the intra unit in the lower layer are not decoded. Therefore, in the enhancement layer, the motion vector, the syntax information, and the like of the lower layer may be referred, but texture information for other units except the intra unit may not be referred. Meanwhile, the multi-loop scheme is a scheme that restores both the layer to be currently reproduced and the lower layer. Accordingly, all texture information may be referred in addition to the syntax information of the lower layer by using the multi-loop scheme.

FIG. 9 is a diagram illustrating a base layer picture 40a of a scalable video signal and an upsampling picture 40b corresponding thereto according to an exemplary embodiment of the present invention. In the exemplary embodiment of FIG. 9, each of the base layer picture 40a and the upsampling picture 40b is partitioned into two slices.

In the scalable video coding, pictures of the base layer and the enhancement layer having a reference relationship may be both partitioned into a plurality of slices and a plurality of tiles. As described above, each of the slice and tile is constituted by a set of CTUs having the same size. In the specification, a term called “partition” may be used as a concept including both the slice and the tile partitioning the picture.

The interlayer prediction may be used to process the coding unit of the enhancement layer. For the interlayer prediction in the video signal having the spatial scalability, the reference unit of the reference layer (that is, the base layer) corresponding to the current unit of the enhancement layer needs to be upsampled. In this case, the current unit and the reference unit may be collocated units included in each of same time pictures in terms of the output order. However, when the samples of the reference layer are picture-based upsampled, the upsampling may be performed without considering a partition (slice or tile) boundary of the reference picture.

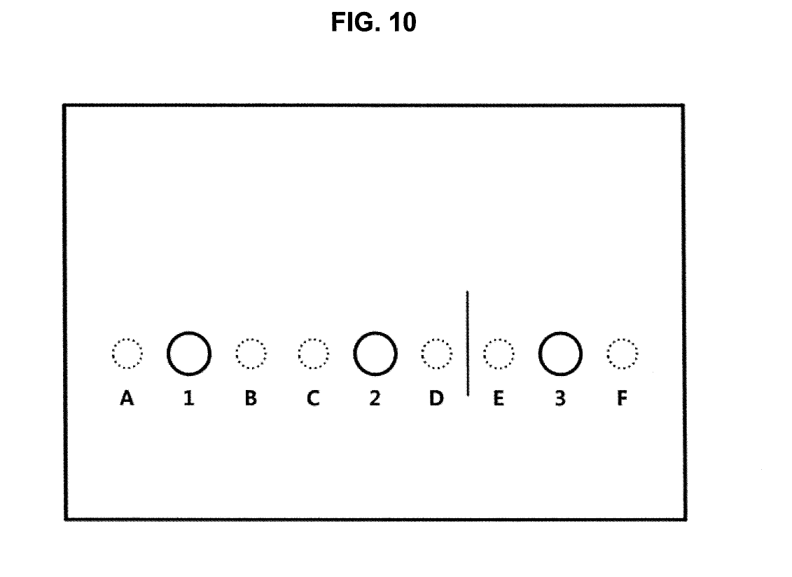

FIG. 10 is a diagram illustrating upsampled samples on a partition boundary according to the present invention. In FIG. 10, samples 1, 2, and 3 illustrated by a solid line represent original samples of a base layer picture and A to F illustrated by a dotted line represent new samples generated by upsampling.

As described above, when the picture-based upsampling is performed, even in the case where two adjacent original samples are not positioned at the same partition, the original samples may be used to generate new samples. For example, original sample 2 and original sample 3 which are not positioned at the same partition may be used to generate new samples D and E. However, as such, when the picture-based upsampling is performed, the upsampling may become an obstacle of parallel processing when decoding a scalable video signal.

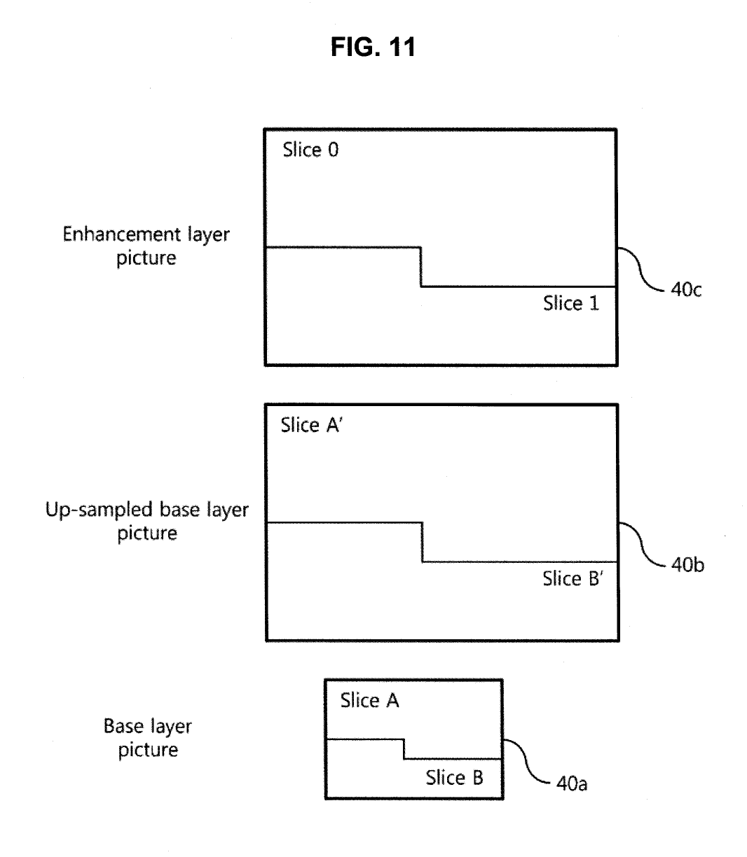

FIG. 11 illustrates an exemplary embodiment of a base layer picture 40a, an upsampled base layer picture 40b, and an enhancement layer picture 40c having a plurality of partitions. In the exemplary embodiment of FIG. 11, each picture is divided into two slices (slice A and slice B, slice A′ and slice B′, and slice 0 and slice 1) and boundaries of the slices are aligned in parallel.

In the exemplary embodiment of FIG. 11, when a slice-based parallel processing is performed for each picture with respect to the base layer picture 40a and the enhancement layer picture 40c, independent processing for respective slices (slice A′ and slice B′) of the upsampled base layer picture 40b is required. However, when the picture-based upsampling for the base layer picture 40a is performed, slice B′ of the upsampled base layer picture 40b is not available until the processing for slice A of the base layer picture 40a is completed.

In order to solve such a problem, according to the exemplary embodiment of the present invention, a partition-based upsampling may be performed. The partition-based upsampling means generating upsampled samples only by using adjacent samples positioned in the same partition. In the present invention, the partition-based upsampling includes slice-based upsampling and tile-based upsampling.

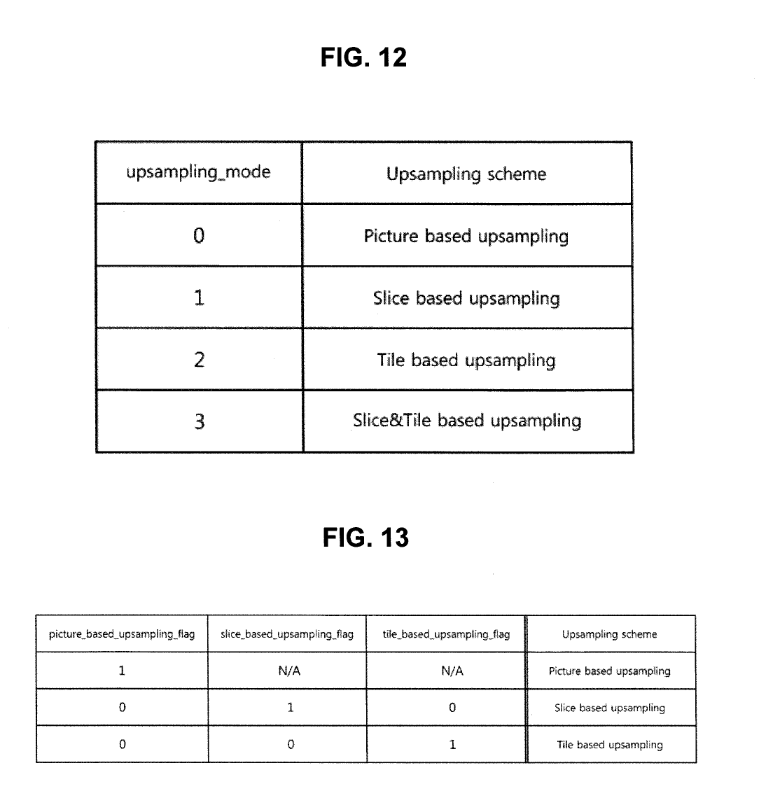

FIG. 12 illustrates upsampling_mode information indicating an upsampling scheme as an exemplary embodiment of the present invention. The upsampling_mode information may be included in a video parameter set (VPS), a sequence parameter set (SPS), a picture parameter set (PPS), or an extended set thereof or included in supplemental enhancement information (SEI), and may have a size of 2 bits.

According to an exemplary embodiment, when the upsampling_mode information value is 0, the picture-based upsampling is used, and when the upsampling_mode information value is 1, the slice-based upsampling may be used. Further, when the upsampling_mode information value is 2, the tile-based upsampling may be used. Meanwhile, the upsampling_mode information value of 3 may represent the slice & tile-based upsampling, or may be used as a reserved value. However, the upsampling type indicated by each of the enumerated upsampling_mode information is just an exemplary embodiment and the upsampling_mode information mapped by each upsampling type may be set different from this embodiment.

FIGS. 13 to 15 illustrate flag information indicating whether to perform upsampling according to each partition type as another exemplary embodiment of the present invention

In detail, a picture_based_upsampling_flag, a slice_based_upsampling_flag, and a tile_based_upsampling_flag may be used. The flags may be included in a video parameter set (VPS), a sequence parameter set (SPS), a picture parameter set (PPS), or an extended set thereof or included in supplemental enhancement information (SEI).

First, referring to FIG. 13, an upsampling type may be indicated by using a combination of the three flags. When the picture_based_upsampling_flag value is 1, the picture-based upsampling may be used. On the contrary, when the picture_based_upsampling_flag value is 0, at least one of the slice-based upsampling and the tile-based upsampling may be used. In this case, when the slice_based_upsampling_flag value is 1, the slice-based upsampling is used, and when the slice_based_upsampling_flag value is 0, the slice-based upsampling may not be used. Similarly, when the tile_based_upsampling_flag value is 1, the tile-based upsampling is used, and when the tile_based_upsampling_flag value is 0, the tile-based upsampling may not be used. When the picture_based_upsampling_flag value is 1, since it is obvious that the picture-based upsampling is performed, the slice_based_upsampling_flag and the tile_based_upsampling_flag may not be included in a bitstream.

Meanwhile, for coding efficiency, the slice-based upsampling and the tile-based upsampling are not simultaneously used. That is, when the picture-based sampling is not used, the slice-based upsampling or the tile-based upsampling is used and only any one of the two upsampling types may be used. In the case where a plurality of slices and a plurality of tiles exist together, when the picture-based upsampling is not used, only the tile-based upsampling may be used.

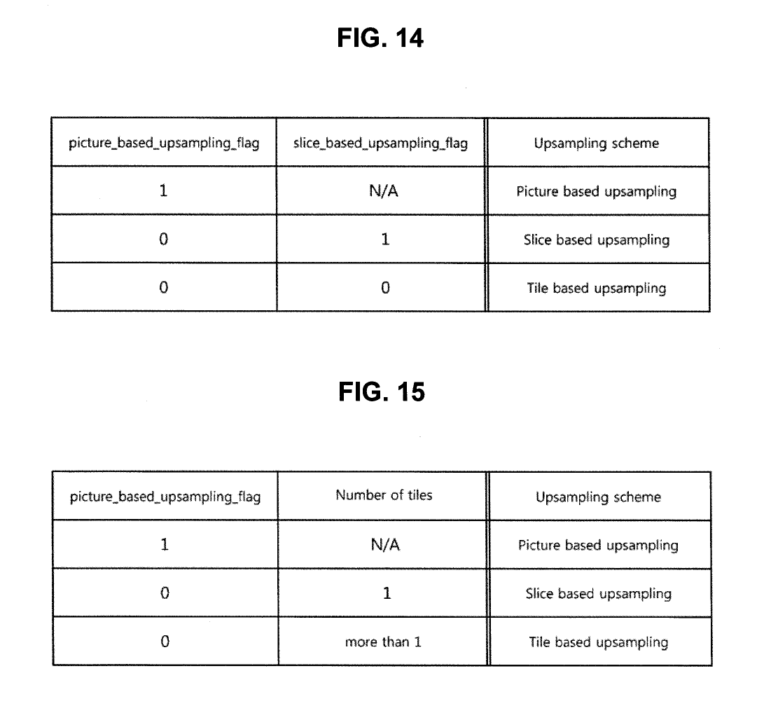

Next, referring to FIG. 14, the upsampling type may be indicated by using a combination of two flags among the three flags. For example, as illustrated in FIG. 14, a combination of the picture_based_upsampling_flag and the slice_based_upsampling_flag may be used.

When the picture_based_upsampling_flag value is 1, the picture-based upsampling is used, and when the value is 0, the slice-based upsampling or the tile-based upsampling may be used. When the slice_based_upsampling_flag value is 1, the slice-based upsampling is used, and when the value is 0, the tile-based upsampling may be used. Meanwhile, when the picture_based_upsampling_flag value is 1, the slice_based_upsampling_flag may not be included in the bitstream. Meanwhile, according to another exemplary embodiment of the present invention, even though a combination of the picture_based_upsampling_flag and the tile_based_upsampling_flag is used, the upsampling type may be indicated by a similar method.

Next, referring to FIG. 15, the upsampling type may be indicated by using only one flag, that is, the picture_based_upsampling_flag. When the picture_based_upsampling_flag value is 1, the picture-based upsampling is used, and when the value is 0, the slice-based upsampling or the tile-based upsampling may be used. When the picture_based_upsampling_flag value is 0 and the tile-based partitioning of the corresponding picture is not performed (that is, when the entire picture is composed of one tile), the slice-based upsampling may be used. However, when the picture_based_upsampling_flag value is 0 and one or more tiles exist in the corresponding picture, the tile-based upsampling may be used.

Meanwhile, according to yet another exemplary embodiment of the present invention, when a plurality of slices and/or a plurality of tiles exist in the picture, partition (slice and/or tile)-based in-loop filtering for the corresponding picture may be performed. The in-loop filter is a filter applied to a restored picture for generating a picture to be output to the reproduction apparatus and to be inserted to the decoded picture buffer.

According to an exemplary embodiment, when a partition-based upsampling is used in the base layer picture, in the corresponding picture, in-loop filtering between the partitions may be prohibited. According to another exemplary embodiment, when the in-loop filtering between the partitions is permitted in the base layer picture, the partition-based upsampling of the corresponding picture may be prohibited.

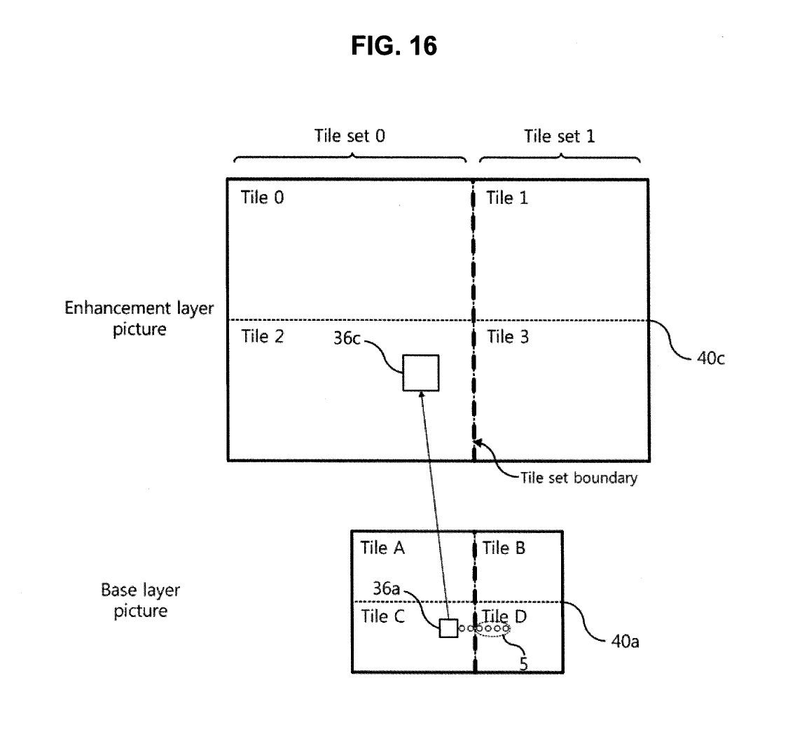

FIG. 16 illustrates tile sets which exist in the base layer picture 40a and the enhancement layer picture 40c according to the exemplary embodiment of the present invention. In the present invention, the tile set illustrates an area configured by one or more tiles. Referring to FIG. 16, the base layer picture 40a is segmented into four tiles, that is, tile A, tile B, tile C, and tile D, and the enhancement layer picture 40c is also segmented into four tiles corresponding thereto, that is, tile 0, tile 1, tile 2, and tile 3. In this case, tile 0 and tile 2 of the enhancement layer picture 40c form the same tile set (that is, tile set 0), and tile 1 and tile 3 form the same tile set (that is, tile set 1). Meanwhile, like the exemplary embodiment of FIG. 16, when a tile boundary of the enhancement layer picture 40c and the base layer picture 40a is aligned, a tile set area specified in the enhancement layer picture 40c may be equally or correspondingly applied to the base layer picture 40a.

According to the exemplary embodiment of the present invention, an ‘interlayer constrained tile sets information’ (interlayer constrained tile sets SEI message) may be used in the scalable video coding. That is, interlayer prediction may be constrained to be performed only in the designated tile set by using the ‘interlayer constrained tile sets information’. In more detail, the ‘interlayer constrained tile sets information’ prevents samples (Type-2 samples) outside the designated tile set and samples (Type-3 samples) at fractional sample positions derived by using at least one sample (Type-2 sample) outside the designated tile set from being used in the interlayer prediction for samples (Type-1 samples) within the corresponding designated tile set. In this case, the Type-1 sample is a sample of the enhancement layer picture 40c and the Type-2 sample and the Type-3 sample may be samples of the base layer picture 40a. Referring to FIG. 16, during decoding/encoding a current unit 36c existing in tile set 0, a reference unit 36a of the base layer picture 40a within the designated tile set may be used in the interlayer prediction of the current unit 36c, but samples 5 positioned outside the designated tile set may not be used in the interlayer prediction of the current unit 36c.

According to the exemplary embodiment to the present invention, the constraints for the tile set may be set by using predetermined index information. For example, index information having a size of 2 bits may be used. The index information value of 1 may represent that the samples (Type-2 samples) outside the designated tile set and the samples (Type-3 samples) at fractional sample positions derived by using at least one sample (Type-2 sample) existing outside the designated tile set are not used in the interlayer prediction for a sample (Type-1 sample) within the corresponding designated tile set. In this case, the Type-1 sample is a sample of the enhancement layer picture 40c and the Type-2 sample and the Type-3 sample may be samples of the base layer picture 40a.

The index information value of 2 may represent that the interlayer prediction is not performed in all units positioned in the designated tile set of the enhancement layer picture 40c. That is, in all units positioned in the designated tile set of the enhancement layer picture 40c, the interlayer prediction using the base layer picture 40a as the reference picture is not performed.

The index information value of 0 may represent that the interlayer prediction may be limited or not with respect to all units positioned in the designated tile set of the enhancement layer picture 40c. Meanwhile, the index information value of 3 may be used as a reserved value.

The aforementioned index information may be included in the ‘interlayer constrained tile sets information’. Further, the index information may be individually set with respect to a specific tile set and may also be equally set with respect to all tile sets.

The encoding apparatus of the present invention generates the ‘interlayer constrained tile sets information’ and/or the index information, and incorporate than into the bitstream. The decoding apparatus receives the ‘interlayer constrained tile sets information’ and/or the index information and may perform the interlayer prediction based on the received information.

Hereinabove, the ‘interlayer constrained tile sets information’ is described, but by a similar method, the ‘interlayer constrained slice sets information’ (interlayer constrained slice sets SEI message) or the ‘interlayer constrained partition sets information’ (interlayer constrained partition sets SEI message) may be used in the scalable video coding.

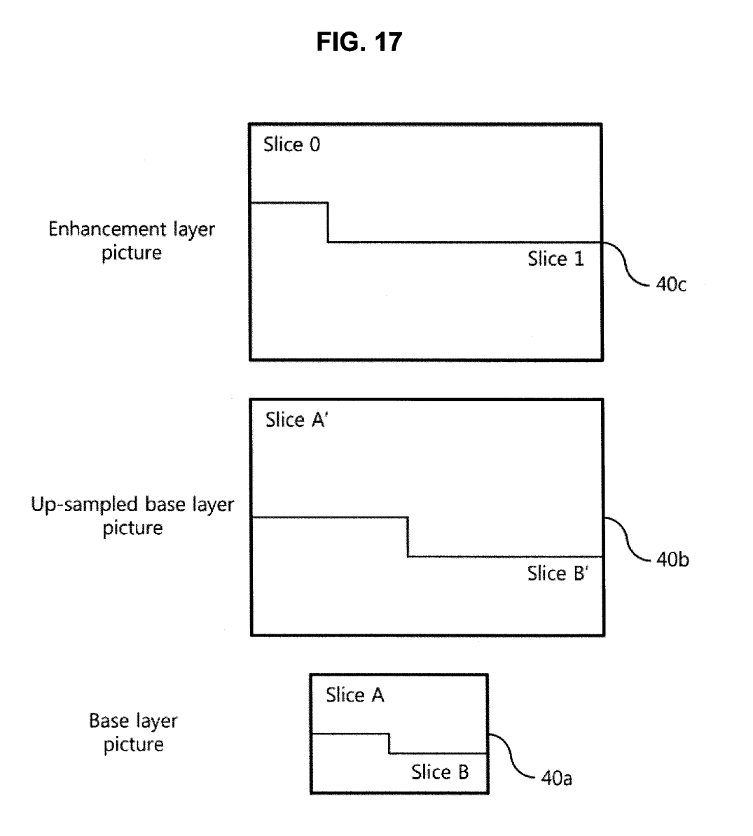

FIG. 17 which illustrates yet another exemplary embodiment of the present invention illustrates a base layer picture 40a and an enhancement layer picture 40c which have different partition boundaries. When the partition boundaries of the base layer picture and the enhancement layer picture are not aligned with each other, it may be not efficient in parallel processing to perform partition-based upsampling. In the present invention, the alignment of the partition boundaries means that collocated samples of the base layer each corresponding to any two samples belonging to the same partition of the enhancement layer picture, respectively belong to the same partition and collocated samples of the base layer picture each corresponding to any two samples belonging to different partitions of the enhancement layer, respectively belong to different partitions.

Accordingly, the following constraint may be used for coding efficiency. When the partition-based upsampling is used, the partition boundary of the enhancement layer picture 40c needs to be aligned with the partition boundary of the base layer picture 40a. Alternatively, when the partition boundary of the enhancement layer picture 40c and the partition boundary of the base layer picture 40a are not aligned with each other, the partition-based upsampling is prohibited.

Meanwhile, whether the partition boundary of the enhancement layer picture 40c and the partition boundary of the base layer picture 40a are aligned with each other may be transferred through a predetermined flag. That is to say, at least one of a ‘flag (tiles_boundaries_aligned_flag) indicating whether tile boundaries of layers are aligned’, a ‘flag (slice_boundaries_aligned_flag) indicating whether slice boundaries of the layers are aligned’, and a ‘flag (partition_boundaries_aligned_flag) indicating whether partition boundaries of the layers are aligned’ may be received through the bitstream.

According to the exemplary embodiment of the present invention, the aforementioned ‘interlayer constrained tile sets information’ (interlayer constrained tile sets SEI message) may be received only when the ‘flag (tiles_boundaries_aligned_flag) indicating whether tile boundaries of layers are aligned’ equals to 1. However, when the ‘flag indicating whether tile boundaries of layers are aligned’ is not equal to 1 for all picture parameter sets, the ‘interlayer constrained tile sets information’ may not exist.

Hereinabove, although the present invention has been described through detailed exemplary embodiments, those skilled in the art can modify and change the present invention without departing from the intent and the scope of the present invention. Accordingly, it is analyzed that a matter which those skilled in the art can easily analogize from the detailed description and the exemplary embodiments of the present invention belongs to the scope of the present invention.

### MODE FOR INVENTION

As above, various embodiments have been described in the best mode.

### INDUSTRIAL APPLICABILITY

The present invention can be applied for processing and outputting a video signal.

What is claimed is:

1. A method for processing a video signal, the method comprising:
receiving a scalable video signal including a base layer and an enhancement layer;
receiving interlayer constrained partition sets information, the interlayer constrained partition sets information indicating whether interlayer prediction is performed only in a designated partition set;
decoding pictures of the base layer; and
decoding pictures of the enhancement layer by referring to the decoded pictures of the base layer,
wherein in the decoding of the pictures of the enhancement layer, the interlayer prediction is performed only in the designated partition set based on the interlayer constrained partition sets information.

2. The method of claim 1, wherein in the decoding of the picture of the enhancement layer, no sample outside the designated partition set is used for interlayer prediction of any sample within the corresponding designated partition set.

3. The method of claim 2, wherein no sample at a fractional sample position derived by using at least one sample outside the designated partition set is used for the interlayer prediction of the any sample within the corresponding designated partition set.

4. The method of claim 1, further comprising:
receiving flag information indicating whether partition boundaries of the layers are aligned with each other,
wherein the interlayer constrained partition sets information is received when the flag information indicates that partition boundaries of the layers are aligned with each other.

5. The method of claim 1, wherein the partition includes a tile which is a sequence of an integer number of coding tree units.

6. The method of claim 1, wherein the partition includes a slice which is a sequence of an integer number of coding tree units.

7. An apparatus for processing a video signal, the apparatus comprising:
a demultiplexer receiving a scalable video signal including a base layer and an enhancement layer and receiving interlayer constrained partition sets information, the interlayer constrained partition sets information indicating whether interlayer prediction is performed only in a designated partition set;
a base layer decoder decoding pictures of the base layer; and
an enhancement layer decoder decoding pictures of the enhancement layer by using the decoded pictures of the base layer,
wherein the enhancement layer decoder performs the interlayer prediction only in the designated partition set based on the interlayer constrained partition sets information.
